(19) United States
(12) Patent Application Publication
(10) Pub. No.: US 2009/0318283 A1
(43) Pub. Date: Dec. 24, 2009

(54) CATALYST COMPOSITION AND METHOD

(75) Inventors: Hrishikesh Keshavan, Clifton Park, NY (US); Oltea Puica Siclovan, Rexford, NY (US); Dan Hancu, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/143,088

(22) Filed: Jun. 20, 2008

(51) Int. Cl. B01J 29/06; B01J 29/068; B01J 29/08

(52) U.S. Cl. 502/64; 502/60; 502/79; 502/74

(57) ABSTRACT

A method comprising forming a slurry comprising a first catalyst composition, a second catalyst composition, and a solvent, wherein the first catalyst composition comprises a zeolite and the second catalyst composition comprises a second catalytic metal disposed upon a porous inorganic support; washcoating the slurry onto a substrate; and calcining the washcoated substrate.

### TECHNICAL FIELD

Embodiments may relate to a catalyst composition. Embodiments may relate to a method of making and/or using the catalyst composition.

### DISCUSSION OF ART

Regulations continue to evolve regarding the reduction of the oxide gases of nitrogen (NOx) for diesel engines in trucks and locomotives. NOx gases may be undesirable. A NOx reduction solution may include treating diesel engine exhaust with a catalyst that can reduce NOx to N₂ and O₂ using a reductant. This process may be referred to as selective catalytic reduction or SCR.

In selective catalytic reduction (SCR), a reductant, such as ammonia, is injected into the exhaust gas stream to react with NOx in contact with a catalyst. Where ammonia is used, the molecule forms nitrogen and water. Three types of catalysts have been used in these systems. The types include base metal systems, and zeolite systems. Base metal catalysts operate in the intermediate temperature range (310 degrees Celsius to 400 degrees Celsius), but at high temperatures they may promote oxidation of SO₂ to SO₃. These base metal catalysts may include vanadium pentoxide and titanium dioxide. The zeolites may withstand temperatures up to 600 degrees Celsius and, when impregnated with a base metal, have a wide range of operating temperatures.

Hydrocarbons (HC) may also be used in the selective catalytic reduction of NOx emissions. NOx can be selectively reduced by a variety of organic compounds (e.g. alkanes, olefins, alcohols) over several catalysts under excess O₂ conditions. The injection of diesel or methanol has been explored in heavy-duty stationary diesel engines to supplement the HC in the exhaust stream. However, the conversion efficiency may be reduced outside the narrow temperature range of 300 degrees Celsius to 500 degrees Celsius. In addition, there may be other undesirable properties.

Selective catalytic reduction catalysts may include catalytic metals disposed upon a porous substrate. However, these catalysts may not function properly when NOx reduction is desired during use. Catalyst preparation and deposition on a substrate may be involved and complex. The structure and/or efficacy of the catalyst substrate may be compromised during manufacture. It may be desirable to have a method of processing such catalysts that does not compromise the catalyst activity.

### BRIEF DESCRIPTION

In accordance with an embodiment of the invention, there is provided a method comprising forming a slurry comprising a first catalyst composition, a second catalyst composition, and a solvent, wherein the first catalyst composition comprises a zeolite and the second catalyst composition comprises a second catalytic metal disposed upon a porous inorganic support; washcoating the slurry onto a substrate; and calcining the washcoated substrate.

### BRIEF DESCRIPTION OF THE DRAWINGS

FIG. 1 is a flow diagram of a method of making a catalyst in accordance with an embodiment of the invention.

### DETAILED DESCRIPTION

The invention includes embodiments that relate to a method of making a catalyst. In one embodiment, the catalyst is processed in a manner that does not substantially reduce, degrade or alter its catalytic activity. The catalyst may selectively catalytically reduce a determined component of an exhaust gas stream in contact therewith.

As used herein, without further qualifiers a catalyst is a substance that can cause a change in the rate of a chemical reaction without itself being consumed in the reaction. A slurry is a mixture of a liquid and finely divided particles. A powder is a substance including finely dispersed solid particles. Calcination is a process in which a material is heated to a temperature below its melting point to effect a thermal decomposition or a phase transition other than melting. A zeolite is a crystalline metal oxide material that comprises a micro-porous structure. The term washcoat has its usual meaning in the art of a thin, adherent coating of a catalytic or other material applied to a carrier material, such as a honeycomb-type carrier member, which is sufficiently porous to permit the passage of the gas stream being treated. A catalyst is a substance that increases the rate of a reaction without being consumed in the process. A deflocculant is a substance that reduces the viscosity of a suspension or slurry. A monolith is intended to include a porous, three-dimensional material having a continuous interconnected pore structure in a single piece. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

In one embodiment, the method includes forming a slurry comprising a first catalyst composition, a second catalyst composition, and a solvent. The first catalyst composition comprises a zeolite. The second catalyst composition comprises a catalytic metal disposed upon a porous inorganic material. The zeolites may be naturally occurring or synthetic. Examples of suitable zeolites are zeolite Y, zeolite beta, ferrierite, mordenite, zeolite ZSM-5, or the like, or a combination comprising at least one of the foregoing zeolites. Zeolite ZSM-5 is commercially available from Zeolyst International (Valley Forge, Pa.). An exemplary zeolite is a ferrierite having a silicon to aluminum ratio of about 20.

Examples of commercially available zeolites that may be used in the first catalyst composition are marketed under the following trademarks: CBV100, CBV300, CBV400, CBV500, CBV600, CBV712, CBV720, CBV760, CBV780, CBV901, CP814E, CP814C, CP811C-300, CP914, CP914C, CBV2314, CBV3024E, CBV5524G, CBV8014, CBV28014, CBV10A, CBV21A, CBV90A. The foregoing zeolites are available from Zeolyst International, and may be used individually or in a combination comprising two or more of the zeolites.

In one embodiment, the zeolite particles may have an average particle size of less than about 50 micrometers. In one embodiment, the zeolite particles have an average particle size of about 50 micrometers to about 400 micrometers. In one embodiment, the zeolite particles have an average particle size of about 400 micrometers to about 800 micrometers. In another embodiment, the zeolite particles have an average particle size of about 800 micrometers to about 1600 micrometers.

The zeolite particles may have a surface area of about 200 m²/gm to about 300 m²/gm. In one embodiment, the zeolite particles may have a surface area of about 300 m²/gm to about 400 m²/gm. In another embodiment, the zeolite particles have a surface area of about 400 m²/gm to about 500 m²/gm. In yet another embodiment, the zeolite particles have a surface area of about 500 m²/gm to about 600 m²/gm.

Desirably, the first catalyst composition is present in an amount of about 20 to about 30 wt %, based upon the total weight of the slurry. In one embodiment, the first catalyst composition is present in an amount of about 30 to about 40 wt %, based upon the total weight of the slurry. In another embodiment, the first catalyst composition is present in an amount of about 40 to about 50 wt %, based upon the total weight of the slurry. In another embodiment, the first catalyst composition is present in an amount of about 50 to about 60 wt %, based upon the total weight of the slurry. In another embodiment, the first catalyst composition is present in an amount of about 60 to about 70 wt %, based upon the total weight of the slurry. In yet another embodiment, the first catalyst composition is present in an amount of about 70 to about 80 wt %, based upon the total weight of the slurry. The quantity of the first catalyst composition used will depend on the desired ratio of the first catalyst composition to the second catalyst composition.

The zeolite may be calcined prior to forming the slurry, so that there are no exotherms produced during calcination with the supported catalyst. Any exotherm may alter the cage structure of the zeolite thereby altering the catalytic activity of the zeolite. In addition, calcining the zeolite to produce the H form of the zeolite was found to be advantageous. The H form of the zeolite is the protonic form of the zeolite. Commercially available zeolites are typically obtained in the NH₄ form. During calcination, NH₃ is released to create the H form of the zeolite. In an exemplary embodiment, the zeolite does not comprise any metal ions. It is important that the zeolite remains in the H form during preparation of the catalyst. For example, if Ag attaches to the zeolite (e.g. Ag-CP914C), the catalytic mixture may not show the desired catalytic activity.

In one embodiment the parameters used for calcination will depend on the type of zeolite used. In one embodiment, the zeolite is calcined in N₂ at 100 degrees Celsius for 1 hr, at 550 degrees Celsius for 1 hr, and then in air at 550 degrees Celsius for 5 hrs. Alternatively, the zeolite can be calcined in air at 550 degrees Celsius for 4 hrs with a very slow ramp rate such as 1 deg C./min in dry air feed. The zeolite can also be calcined under vacuum at similar conditions so as to avoid alteration of the cage structure.

As noted above, the second catalyst composition comprises a metal disposed upon a porous inorganic material. The porous inorganic materials may be metal oxides, inorganic oxides, inorganic carbides, inorganic nitrides, inorganic hydroxides, inorganic oxides having a hydroxide coating, inorganic carbonitrides, inorganic oxynitrides, inorganic borides, inorganic borocarbides, or the like, or a combination comprising at least one of the foregoing inorganic materials.

Examples of suitable inorganic oxides include silica (SiO₂), alumina (Al₂O₃), titania (TiO₂), zirconia (ZrO₂), ceria (CeO₂), manganese oxide (MnO₂), zinc oxide (ZnO), iron oxides (e.g., FeO, βFe₂O₃, γ-Fe₂O₃, ε-Fe₂O₃, Fe₃O₄, or the like), calcium oxide (CaO), manganese dioxide (MnO₂ and Mn₃O₄). Examples of inorganic carbides include silicon carbide (SiC), titanium carbide (TiC), tantalum carbide (TaC), tungsten carbide (WC), hafnium carbide (HfC), or the like. Examples of suitable nitrides include silicon nitrides (Si₃N₄), titanium nitride (TiN), or the like. Examples of suitable borides are lanthanum hexa-boride (LaB₆), chromium borides (CrB and CrB₂), molybdenum borides (MoB₂, Mo₂B₅ and MoB), tungsten boride (W₂B₅), or the like. In one embodiment, the inorganic substrate is alumina.

The porous inorganic material may have a surface area of from about 100 m²/g to about 200 m²/gm, from about 200 m²/g to about 300 m²/gm, from about 300 m²/g to about 400 m²/gm, from about 400 m²/g to about 500 m²/gm, from about 500 m²/g to about 600 m²/gm, from about 600 m²/g to about 700 m²/gm, from about 700 m²/g to about 800 m²/gm, from about 800 m²/g to about 1000 m²/gm, from about 1000 m²/g to about 1200 m²/gm, from about 1200 m²/g to about 1300 m²/gm, from about 1300 m²/g to about 1400 m²/gm, from about 1400 m²/g to about 1500 m²/gm, from about 1500 m² g to about 1600 m²/gm, from about 1600 m²/g to about 1700 m²/gm, from about 1700 m²/g to about 1800 m²/gm, or from about 1800 m²/g to about 2000 m²/gm. An exemplary surface area range is from about 200 m²/g to about 500 m²/g.

The porous inorganic material may be in the form of particles. Both the porous inorganic material and the second catalyst composition may in the form of a powder.

The porous inorganic material has an average particle size of about 0.2 micrometers to about 5 micrometers. In one embodiment, the porous inorganic material has an average particle size of about 5 micrometers to about 10 micrometers.

In another embodiment, the porous inorganic material has an average particle size of about 10 micrometers to about 60 micrometers. In another embodiment, the porous inorganic material has an average particle size of about 60 micrometers to about 80 micrometers. In another embodiment, the porous inorganic material has an average particle size of about 80 micrometers to about 100 micrometers. In an exemplary embodiment, the porous inorganic material has an average particle size of about 40 micrometers.

The catalytic metal comprises alkali metals, alkaline earth metals, transition metals and main group metals. Examples of suitable catalytic metals are silver, platinum, gold, palladium, iron, nickel, cobalt, gallium, indium, ruthenium, rhodium, osmium, iridium, or the like, or a combination comprising at least two of the foregoing metals. In one embodiment, the second catalytic metal is silver. Other suitable catalytic materials may include one or more other noble metals. Other suitable catalytic materials may include one or more transitional metals. Other suitable catalytic materials may include one or more metals in the lanthanide series such as cerium and samarium.

The average catalytic metal particle size is about 0.1 nanometer to about 500 nanometers. The catalytic metals are present in the second catalyst composition in an amount of about 0.025 mole percent (mol %) to about 5 mol %. In one embodiment, the catalytic metals are present in the second catalyst composition in an amount of about 5 mol % to about 20 mol %. In another embodiment, the catalytic metals are present in the second catalyst composition in an amount of about 20 mol % to about 30 mol %. In one embodiment, the catalytic metals are present in the second catalyst composition in an amount of about 30 mol % to about 40 mol %. In yet another embodiment, the amount of catalytic metal in the second catalyst composition is about 40 mol % to about 50 mol %.

The second catalyst composition is present in the slurry in an amount of about 20 wt % to about 40 wt %, based upon the total weight of the slurry. In one embodiment, the second catalyst composition is present in the slurry an amount of about 40 wt % to about 60 wt %, based upon the total weight of the slurry. In another embodiment, the second catalyst composition is present in the slurry an amount of about 60 wt % to about 80 wt %, based upon the total weight of the slurry. In yet another embodiment, the second catalyst composition is present in an amount of about 80 wt % to about 95 wt %, based upon the total weight of the slurry.

The first catalyst composition and the second catalyst composition may each be in the form of a powder. In one embodiment, the second catalyst composition powder is formed by combining AgNO₃ to a slurry comprising γ-Al₂O₃. The slurry may be dried by spray drying, freeze-drying, or super-critical drying, followed by calcination to form an Ag—Al₂O₃ powder.

Prior to combining the first catalyst composition and the second catalyst composition, the catalyst compositions may be milled or pulverized to reduce their particle sizes to the desired ranges disclosed herein. Suitable methods for milling the first and second catalyst compositions include ball milling, ultrasonic milling, planetary milling, jet milling. In one embodiment, the first and second catalyst compositions are ball milled.

In one embodiment, the second catalyst composition may be formed by first milling the porous inorganic material, and then adding the catalytic metal to the porous inorganic material.

A slurry may be formed by adding a solvent to the first catalyst composition to form a first catalyst slurry, and then adding the second catalyst composition to the slurry. Alternatively, a slurry may be formed by adding a solvent to the second catalyst composition to form a second catalyst slurry, and then adding the first catalyst composition to the slurry. In another embodiment, the first catalyst slurry and the second catalyst slurry are combined to form a slurry mixture. Suitable solvents for forming each slurry include water, alcohols such as short chain alcohols, polar protic solvents and polar aprotic solvents.

The slurry may be contacted to the catalyst substrate. In one embodiment, the slurry is washcoated onto a low surface area substrate such as a monolith, including a honeycomb monolith, open flow ceramic honeycomb, wall-flow honeycomb, honeycomb monolith body, or a metal honeycomb. Any method known to those having skill in the art may be used to washcoat the slurry onto the substrate. The catalyst support may comprise various materials including, but not limited to cordierite, alumina, mullite, fused silica, activated carbon, zeolites, aluminum titanate, silicon carbide, activated carbon, a zeolite, a refractory oxide, or a combination thereof. In one embodiment of the invention, the catalyst support is a monolith including cordierite.

The catalyst substrate may have a surface area greater than about 0.5 m²/gram. In one embodiment, the surface area is in a range of from about 0.5 m²/gram to about 10 m²/gram, from about 10 m²/gram to about 100 m²/gram, from about 100 m²/gram to about 200 m²/gram, or from about 200 m²/gram to about 1200 m²/gram. In one embodiment, the catalyst substrate has a surface area that is in a range from about 0.5 m²/gram to about 200 m²/gram.

The applied washcoat is then calcined at a temperature greater than about 500 degrees Celsius. In one embodiment, the calcine temperature is in a range of from about 500 degrees Celsius about 750 degrees Celsius, from about 750 degrees Celsius about 900 degrees Celsius, from about 900 degrees Celsius to about 1000 degrees Celsius, or from about 1000 degrees Celsius to about 1200 degrees Celsius. In one embodiment, the calcine temperature is about 1150 degrees Celsius. The parameters used for drying and calcining the washcoat are selected based on the specific catalyst substrate, catalyst, and solvent used in the washcoat slurry.

In one embodiment, the calcination is performed in a reducing atmosphere followed by an oxidizing atmosphere. The washcoat is first calcined in a reducing environment such as N₂, which is slowly changed to an oxidizing environment such as air. This is done to avoid exothermic reactions during calcination, which can be detrimental to fragile zeolite cage structures.

The catalyst disclosed herein is effective at reducing NOx present in emissions generated during combustion in furnaces, ovens, and engines. A synergy exists between the first catalyst composition and the second catalyst composition, which causes an improved reduction in NOx to nitrogen when compared with other comparative catalysts. Without being limited to theory, it is believed that the first catalyst (zeolite) intimately mixed with the second catalyst composition facilitates the conversion of lighter hydrocarbons (C2 to C3) into more efficient NOx reductants, which improve reduction efficiency. When the catalyst is employed to reduce NOx generated in emissions from furnaces, ovens and engines, a variety of hydrocarbons can be effectively used as a reductant. The catalyst advantageously functions well across all temperature ranges, especially at temperatures of about 180 degrees Celsius to about 550 degrees Celsius.

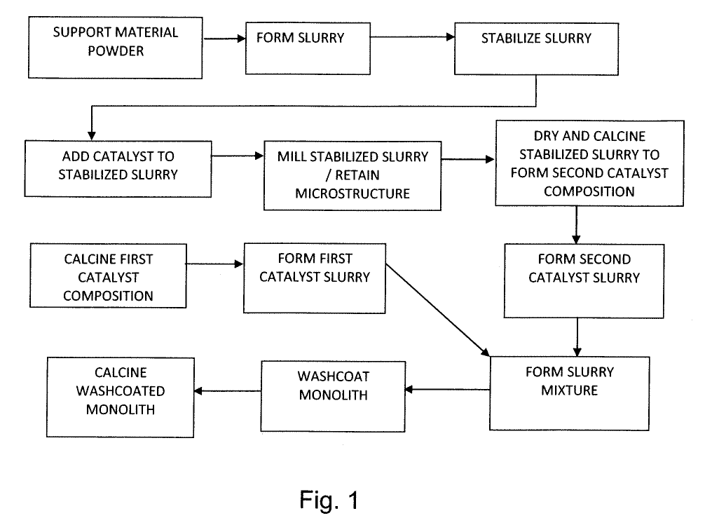

FIG. 1 illustrates a flow diagram of an embodiment for making a catalyst. The method includes calcining a first catalyst composition comprising a zeolite. A solvent is then added to the first catalyst composition to form a first catalyst slurry.

Referring to the top of the diagram in FIG. 1, the method also includes forming a slurry from a support material powder and adding a deflocculant to stabilize the slurry. Examples of suitable deflocculants include Darvan C™ (available from R.T. Vanderbilt Company Inc.), HNO₃, NaOH, TPAOH, TMAOH or any strong base. The deflocculant changes the charge of particles present in the slurry, thereby making the particles repel each other. A catalyst is added to the stabilized slurry and the slurry is milled. An appropriate milling technique is used whereby the microstructure of the support material is retained. The milled slurry is dried and calcined to form the second catalyst composition. A solvent is then added to the second catalyst composition to form a second catalyst slurry. The first catalyst slurry and the second catalyst slurry are combined to form a slurry mixture. The slurry mixture is washcoated onto a monolith, and the monolith is calcined.

### EXAMPLES

The following examples illustrate methods and embodiments in accordance with the invention, and as such should not be construed as imposing limitations upon the claims. Unless specified otherwise, all components are commercially available from common chemical suppliers such as Alpha Aesar, Inc. (Ward Hill, Mass.), Spectrum Chemical Mfg. Corp. (Gardena, Calif.), and the like.

### Example 1

A support material in the form of a 35 mass % γ-Al₂O₃ slurry is prepared. In order to stabilize the slurry, a deflocculant is added to the slurry. The deflocculant is HNO₃ or Darvan—C that changes the charge of the γ-Al₂O₃ particles making the particles repel each other

Grinding media is added to the stabilized slurry. A catalyst in the form of AgNO₃ is added to the stabilized slurry. The stabilized slurry/grinding media/catalyst mixture is pulverized during a ball mill. AgNO₃ is added such that it amounts to the required quantity of Ag doping required in the end powder as shown in Table 1. After the slurry is pulverized, it is dried and calcined.

A first set of each of the samples is calcined in air at 550 degrees Celsius for 4 hrs to form an Ag—Al₂O₃ powder. For comparison, a second set of each of the samples is calcined in N₂ at 100 degrees Celsius for 1 hr, at 550 degrees Celsius for 1 hr, and then in air at 500 degrees Celsius for 5 hrs.

Example 1 has three samples (S1, S2, S3) formed in accordance with Table 1.

TABLE 1
slurry preparation samples

| Sample # | γ-alumina (g) | Water (g) | AgNO₃ (g) | target Ag (wt %) |
|---|---|---|---|---|
| S1 | 30 | 70 | 0.928 | 3 |
| S2 | 30 | 70 | 3.02 | 6 |
| S3 | 40 | 60 | 1.949 | 3 |

Obtain zeolite and calcine prior to addition to the slurry so that there are no exotherms during calcination with the supported catalyst. The NH₄—CP914C zeolite was calcined in N₂ at 100 degrees Celsius for 1 hr, at 550 degrees Celsius for 1 hr, and then in air at 500 degrees Celsius for 5 hrs to form H—CP914C.

The zeolite powder (first catalyst composition) and Ag—Al₂O₃ (supported second catalyst composition) powder are prepared separately, but each in water to form respective slurries. The zeolite powder is ball milled in such a manner as to reduce or avoid alteration of the cage structure of the zeolite. The zeolite is rolled for about an hour to break down agglomerates in the slurry. In this case, sufficient amounts of each slurry are added together so that 30 g of Al₂O₃ is used and 7.5 g of zeolite is used based on a 13 vol % of solids in the respective slurries. The Ag—Al₂O₃ slurry and zeolite slurry were mixed together to form a slurry mix. The slurry mix is washcoated on a monolith. The monolith has a diameter of ¾ inch, a length of 1 inch, and comprises 230 cells per square inch. Such a monolith is available from Corning Inc. or SICCAS (Shanghai Institute of Ceramics, Chinese Academy of Sciences). The washcoated monolith is calcined in dry air at 550 degrees Celsius for 4 hrs.

### Example 2

A zeolite slurry and an Ag—Al₂O₃ slurry are prepared as described above in Example 1. The difference is in the application of the slurries to the monolith, in that there is no slurry mixture formed but the slurries are contacted with the monolith sequentially. The zeolite slurry is washcoated on a monolith and calcined. The Ag—Al₂O₃ slurry is then washcoated onto the zeolite layer and calcined. Precise monitoring of the monolith mass is necessary to deposit the required quantity of Ag—Al₂O₃ on the monolith to obtain a mass ratio of Al₂O₃ to zeolite of 4:1.

### Example 3

A zeolite slurry and an Ag—Al₂O₃ slurry are prepared as described above in Example 1. The difference between Example 2 and this example is in the order of application of the slurries to the monolith is reversed. The Ag—Al₂O₃ slurry is washcoated on a monolith and calcined. The zeolite slurry is then washcoated onto the Ag—Al₂O₃ layer and calcined. Precise monitoring of the monolith mass is necessary to deposit the required quantity of zeolite on the monolith to obtain a mass ratio of Al₂O₃ to zeolite of 4:1.

### Example 4

A catalyst is prepared as described above in Example 1, except that NaOH is used to maintain the pH of the alumina slurry in a range of from about 8-10, and the strong base serves as the deflocculant instead of HNO₃.

### Example 5

A catalyst is prepared as described above in Example 1, except the deflocculant used is DARVAN C, which is an ammonium polyacrylate solution available from Vanderbilt Corporation. The deflocculant in this example is a polymer and is used to coat each γ-Al₂O₃ particle.

All ranges disclosed herein are inclusive of the endpoints, and the endpoints are combinable with each other. The terms “first,” “second,” and the like as used herein do not denote any order, quantity, or importance, but rather are used to distinguish one element from another. The use of the terms “a” and “an” and “the” and similar referents in the context of describing the invention (especially in the context of the following claims) are to be construed to cover both the singular and the plural, unless otherwise indicated herein or contradicted by context.

While the invention has been described in detail in connection with a number of embodiments, the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method, comprising:
forming a slurry comprising a first catalyst composition, a second catalyst composition, and a solvent, wherein the first catalyst composition comprises a zeolite and the second catalyst composition comprises a second catalytic metal disposed upon a porous inorganic support;
washcoating the slurry onto a substrate; and
calcining the washcoated substrate.

2. The method as defined in claim 1, further comprising selecting the zeolite to comprise one or more of zeolite Y, zeolite beta, ferrierite, mordenite, or zeolite ZSM-5.

3. The method as defined in claim 2, wherein the zeolite is ferrierite.

4. The method as defined in claim 3, wherein the ferrierite has a silicon to aluminum molar ratio of 20.

5. The method as defined in claim 3, wherein the ferrierite has a surface area in a range of from about 200 m²/gm to about 500 m²/gm.

6. The method as defined in claim 1, further comprising selecting the second catalytic metal to comprise one or more of silver, gold, palladium, cobalt, nickel, or iron.

7. The method as defined in claim 6, wherein the second catalytic metal consists essentially of silver.

8. The method claim 1, further comprising selecting the porous inorganic material to comprise one or more of a metal oxide, an inorganic oxide, an inorganic carbide, an inorganic nitride, an inorganic hydroxide, an inorganic oxide having a hydroxide coating, an inorganic carbonitride, an inorganic oxynitride, an inorganic boride, or an inorganic borocarbide.

9. The method as defined in claim 8, wherein the porous inorganic material comprises silica, titania, zirconia, ceria, manganese oxide, zinc oxide, iron oxide, calcium oxide, manganese dioxide, silicon carbide, titanium carbide, tantalum carbide, tungsten carbide, hafnium carbide, silicon nitrides, titanium nitride, lanthanum boride, chromium borides, molybdenum borides, or tungsten boride.

10. The method as defined in claim 8, wherein the porous inorganic material is alumina.

11. The method as defined in claim 1, wherein the first catalyst composition is present in an amount in a range of from about 5 weight percent to about 80 weight percent based upon the weight of a dried solid content of the slurry.

12. The method as defined in claim 1, wherein the second catalyst composition is present in an amount in a range of from about 20 weight percent to about 95 weight percent based upon the weight of a dried solid content of the slurry.

13. The method as defined in claim 1, wherein the first catalyst composition is a powder and the method further comprises:
milling the first catalyst composition prior to forming the slurry.

14. The method as defined in claim 13, wherein milling comprises ball milling, ultrasonic milling, jet milling, or planetary milling.

15. The method as defined in claim 1, wherein the second catalyst composition is a powder and the method further comprises:
milling the second catalyst composition prior to forming the slurry.

16. The method as defined in claim 1, wherein calcining the washcoat is at a calcining temperature that is in a range of from about 500 degrees Celsius to about 1200 degrees Celsius.

17. The method as defined in claim 1, wherein calcining the washcoat is in a reducing environment.

18. The method of as defined in claim 1, wherein calcining the washcoat is in an oxidizing environment.

19. The method as defined in claim 1, wherein the second catalyst composition is formed by milling the porous inorganic material while maintaining the microstructure of the porous inorganic material, and securing the catalytic metal to the milled porous inorganic material.

20. The method as defined in claim 1, further comprising selecting the solvent to comprise water or an alcohol.

21. The method as defined in claim 1, wherein the substrate has a surface area less than approximately 2,000 m²/g.

22. The method as defined in claim 1, further comprising adding a deflocculant to the slurry.

23. A washcoated monolith formed by the method as defined in claim 1.
